(19) United States
(12) Patent Application Publication
(10) Pub. No.: US 2020/0020188 A1
(43) Pub. Date: Jan. 16, 2020

(54) METHOD FOR CONTROLLING KEY BY USING RULE AND DEVICE THEREFOR

(71) Applicant: Samsung Electronics Co., Ltd., Gyeonggi-do (KR)

(72) Inventors: Sejung SHIN, Seoul (KR); Hojung LEE, Seoul (KR)

(21) Appl. No.: 16/494,495

(22) PCT Filed: Dec. 1, 2017
(86) PCT No.: PCT/KR2017/014000

§ 371 Date: Sep. 16, 2019

(30) Foreign Application Priority Data
Mar. 16, 2017 (KR) 10-2017 0032986

(51) Int. Cl. G07C 9/00

(52) U.S. Cl. CPC G07C 9/00857; H04L 67/42; G07C 2009/0088

(57) ABSTRACT

An electronic device is disclosed. The disclosed electronic device comprises: a memory; a communication module for performing communication with a server; and a processor electrically connected to the memory and the communication module, wherein the processor: receives a key for releasing a door lock from the server through the communication module, and a rule including use conditions for the key and an action to be executed when the conditions are satisfied and stores the same in the memory; and can execute the action on the basis of an event and the rule when the event occurs inside or outside the electronic device.

### BACKGROUND ART

The disclosure relates to a method of controlling a key using a rule, and an electronic device therefor.

As communication technology has developed, a technology that enables an electronic device to generate a key and unlock a door lock has been developed. The door lock unlocking system is referred to as a smart key system. The smart key system may be utilized for various fields such as cars, houses, hotels, offices, and the like.

### DISCLOSURE OF INVENTION

### Technical Problem

According to a smart key system, when a key is generated once for a house or a car, the key may be permanently used. However, for the purpose of business related to hotels or the like, a key may be frequently issued, deleted, and transmitted. In this instance, a processor is needed to manage the process of issuing, deleting, and transmitting a key.

According to various embodiments, the process of issuing, deleting, and transmitting a key is performed using a rule, and thus a key may be automatically issued, deleted, and transmitted according to context of an electronic device.

In accordance with an aspect of the disclosure, an electronic device may include: a memory; a communication module configured to perform communication with a server; and a processor configured to be electrically connected to the memory and the communication module, and the processor is configured to: receive a key to unlock a door lock and a rule including a condition for using the key and an action to be performed when the condition is satisfied, from the server via the communication module, and store the key and the rule in the memory; and when an event occurs inside or outside the electronic device, perform the action on the basis of the event and the rule.

The event may occur on the basis of at least one of location information and time information of the electronic device.

The time information may be received from the server.

The action may include a function of transmitting the key to the door lock or another electronic device, or a function of deleting the key from the memory.

The event may occur on the basis of a user input, and the processor may transmit the key to another electronic device on the basis of the user input.

The processor may perform the action, and may use information associated with a result of performing the action as condition data for performing the rule.

The processor may perform the action, and use information associated with a result of performing the action as data that generates the event.

The key may include the rule.

In accordance with an aspect of the disclosure, a server may include: a memory configured to store a key to unlock a door lock, and a rule including a condition for using the key and an action to be performed when the condition is satisfied; a communication module configured to communicate with an electronic device; a processor configured to be electrically connected to the memory and the communication module, and the processor may be configured to: receive location information of the electronic device via the communication module, and read the rule from the memory; and transmit the key to the electronic device on the basis of the location information and the rule.

The processor may transmit, to the electronic device, a command to delete the key stored in the electronic device on the basis of time information of the server.

In accordance with an aspect of the disclosure, a method of unlocking a door lock by an electronic device may include: receiving a key to unlock a door lock and a rule including a condition for using the key and an action to be performed when the condition is satisfied, from a server via a communication module; storing the key and the rule in a memory; receiving an event occurring inside or outside the electronic device; and performing the action on the basis of the event and the rule.

The event may include at least one of user information, ID information, location information, and time information of the electronic device.

The time information may be received from the server.

The action may include a function of transmitting the key to the door lock or another electronic device, or a function of deleting the key from the memory.

The event may further include a user input, and the method of unlocking the door lock by the electronic device may further include transmitting the key to another electronic device on the basis of the user input. Also, the method may perform the action, and may use information associated with a result of performing the action as condition data for performing the rule. Also, the method performs the action, and may use the result of performing the action as event information. The key may include the rule.

In accordance with an aspect of the disclosure, a method of managing a door lock key by a server may include: receiving location information of an electronic device via a communication module; reading a rule including a condition for using a key to unlock a door lock and an action to be performed when the condition is satisfied, from a memory; and transmitting the key to the electronic device on the basis of the rule and the location information.

The method may further include transmitting, to the electronic device, a command to delete the key stored in the electronic device on the basis of time information of the server

### BRIEF DESCRIPTION OF DRAWINGS

FIG. 1 is a diagram illustrating an electronic device within a network environment according to various embodiments;

FIG. 2 is a block diagram of an electronic device according to various embodiments;

FIG. 3 is a block diagram of a program module according to various embodiments;

FIG. 4 is a diagram illustrating an example in which a server and an electronic device issue, delete, and transmit a key on the basis of a rule according to various embodiments;

FIG. 5 is a flowchart illustrating a process in which an electronic device receives a rule from a server, and performs various actions on the basis of a rule according to various embodiments;

FIG. 6 is a flowchart illustrating a process in which a server deletes a key on the basis of a rule according to various embodiments;

FIG. 7 is a block diagram of a server according to various embodiments;

FIG. 8 is a block diagram of a door lock according to various embodiments;

FIG. 9 is a diagram illustrating an example of the structure of a key that a server transmits to an electronic device according to various embodiments;

FIG. 10 is a diagram illustrating the structure of a rule set according to various embodiments;

FIG. 11 is a block diagram of a rule engine that processes a rule in an electronic device according to various embodiments;

FIG. 12 is a diagram illustrating an example in which a server issues a key to a user on the basis of a rule and location information of the user according to various embodiments;

FIG. 13 is a diagram illustrating an example in which a server transmits a message on the basis of a rule and location information of an electronic device according to various embodiments;

FIG. 14 is a diagram illustrating an example in which an electronic device transmits a key to a door lock on the basis of a rule according to various embodiments;

FIG. 15 is a diagram illustrating an example in which an electronic device shares a key with a second electronic device on the basis of a rule according to various embodiments; and

FIG. 16 is a diagram illustrating an example in which a server deletes a key stored in an electronic device according to various embodiments.

### BEST MODE FOR CARRYING OUT THE INVENTION

Hereinafter, various embodiments of the present disclosure are disclosed with reference to the accompanying drawings. However, the present disclosure is not intended to be limited by the various embodiments of the present disclosure to a specific embodiment and it is intended that the present disclosure covers all modifications, equivalents, and/or alternatives of the present disclosure provided they come within the scope of the appended claims and their equivalents. With respect to the descriptions of the accompanying drawings, like reference numerals refer to like elements. The terms of a singular form may include plural forms unless they have a clearly different meaning in the context. As used herein, the expressions “A or B” or “at least one of A and/or B” may include any one of, or all possible combinations of items enumerated together in a corresponding one of the expressions. As used herein, such terms as “1st” and “2nd,” or “first” and “second” may be used to simply distinguish a corresponding component from another, and does not limit the components in other aspect (e.g., importance or order). It is intended that when a component (for example, a first component) is referred to as being “operatively or communicatively coupled with/to” or “connected to” another component (for example, a second component), the component may be directly connected to the other component or connected through another component (for example, a third component).

The expression “configured to” used in various embodiments of the present disclosure may be interchangeably used with “suitable for,” “having the capacity to,” “designed to,” “adapted to,” “made to,” or “capable of” according to the situation, for example. The term “configured to” may not necessarily indicate “specifically designed to” in terms of hardware. Instead, the expression “a device configured to” in some situations may indicate that the device and another device or part are “capable of.” For example, the expression “a processor configured to perform A, B, and C” may indicate a dedicated processor (for example, an embedded processor) for performing a corresponding operation or a general purpose processor (for example, a central processing unit (CPU) or application processor (AP)) for performing corresponding operations by executing at least one software program stored in a memory device.

An electronic device according to various embodiments of the present disclosure may include at least one of a smartphone, a tablet personal computer (PC), a mobile phone, a video telephone, an electronic book reader, a desktop PC, a laptop PC, a netbook computer, a workstation, a server, a personal digital assistant (PDA), a portable multimedia player (PMP), a Motion Picture Experts Group (MPEG-1 or MPEG-2) Audio Layer 3 (MP3) player, a mobile medical device, a camera, or a wearable device. The wearable device may include at least one of an accessory-type device (e.g., a watch, a ring, a bracelet, an anklet, a necklace, glasses, a contact lens, a head-mounted device (HMD)), a textile- or clothing-integrated-type device (e.g., an electronic apparel), a body-attached-type device (e.g., a skin pad or a tattoo), or a bio-implantable-type device (e.g., an implantable circuit). In some various embodiments of the present disclosure, an electronic device may include at least one of, for example, a television (TV), a digital video/versatile disc (DVD) player, an audio, a refrigerator, an air conditioner, a cleaner, an oven, a microwave oven, a washing machine, an air cleaner, a set-top box, a home automation control panel, a security control panel, a media box (e.g., Samsung HomeSync™, Apple TV™, or Google TV™), a game console (e.g., Xbox™ or PlayStation™), an electronic dictionary, an electronic key, a camcorder, or an electronic picture frame.

In other various embodiments of the present disclosure, an electronic device may include at least one of various medical devices (e.g., various portable medical measurement devices (e.g., a blood glucose measuring device, a heart rate measuring device, a blood pressure measuring device, a body temperature measuring device, or the like), a magnetic resonance angiography (MRA), a magnetic resonance imaging (MRI), a computed tomography (CT), a scanner, an ultrasonic device, or the like), a navigation device, a global navigation satellite system (GNSS), an event data recorder (EDR), a flight data recorder (FDR), a vehicle infotainment device, electronic equipment for vessels (e.g., a navigation system, a gyrocompass, or the like), avionics, a security device, a head unit for a vehicle, an industrial or home robot, a drone, an automatic teller machine (ATM), a point of sales (POS) device of a store, or an Internet of things (IoT) device (e.g., a light bulb, various sensors, an electric or gas meter, a sprinkler, a fire alarm, a thermostat, a streetlamp, a toaster, exercise equipment, a hot water tank, a heater, a boiler, or the like). According to various embodiments of the present disclosure, an electronic device may include at least one of a part of furniture, a building/structure or a vehicle, an electronic board, an electronic signature receiving device, a projector, or a measuring instrument (e.g., a water meter, an electricity meter, a gas meter, a wave meter, or the like). An electronic device may be one or more combinations of the above-mentioned devices. An electronic device according to some various embodiments of the present disclosure may be a flexible device. An electronic device according to an embodiment of the present disclosure is not limited to the above-mentioned devices. The term “user” used herein may refer to a person who uses an electronic device or may refer to a device (e.g., an artificial intelligence electronic device) that uses an electronic device.

The term “issuing” of a key used throughout the specifications indicates that a server transmits a key to an electronic device or a second electronic device. The second electronic device indicates an electronic device of another user.

The term “deletion” of a key used throughout the specifications indicates that a key stored in a server or an electronic device is deleted or disabled.

The term “transmission” of a key used throughout the specifications indicates that a key is transmitted to a door lock.

The term “rule” mentioned throughout the specifications indicates text that defines a condition that is required when a server or an electronic device performs a command, and defines an action to be performed when the condition is satisfied.

The term “rule set” mentioned throughout the specifications is a set of a plurality of rules, and the expression “readout or transmission of a rule set” may indicate “readout and transmission of a rule”.

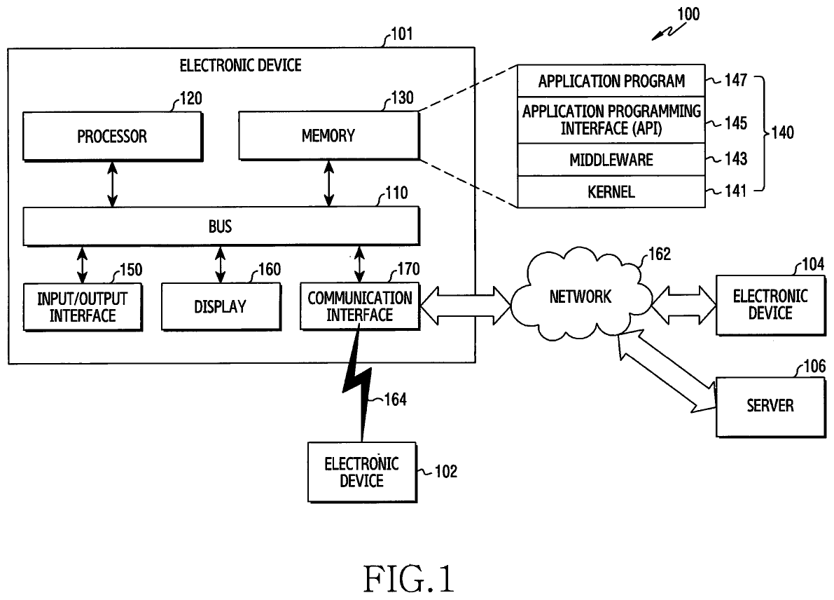

FIG. 1 is a diagram illustrating an electronic device within a network environment according to various embodiments.

Referring to FIG. 1, an electronic device 101 within a network environment 100 according to various embodiments will be described. The electronic device 101 may include a bus 110, a processor 120, a memory 130, an input/output interface 150, a display 160, and a communication interface 170. According to an embodiment, the electronic device 101 may omit at least one of the above-described elements or may further include other elements. The bus 110 may connect the elements 110 to 170, and may include a circuit for delivering communication (e.g., a control message or data) between the elements. The processor 120 may include one or more of a central processing unit, an application processor, and a communication processor (CP). The processor 120, for example, may carry out operations or data processing relating to control and/or communication of at least one other element of the electronic device 101.

The memory 130 may include volatile and/or non-volatile memory. The memory 130 may store, for example, commands or data relevant to at least one other element of the electronic device 101. According to an embodiment, the memory 130 may store software and/or a program 140. For example, the program 140 may include a kernel 141, middleware 143, an application programming interface (API) 145, and/or application programs (or “applications”) 147. At least some of the kernel 141, the middleware 143, and the API 145 may be referred to as an operating system. The kernel 141 may control or manage, for example, system resources (e.g., the bus 110, the processor 120, the memory 130, or the like) used for executing operations or functions implemented in other programs (e.g., the middleware 143, the API 145, or the application programs 147). Furthermore, the kernel 141 may provide an interface via which the middleware 143, the API 145, or the applications 147 may access the individual elements of the electronic device 101 to control or manage the system resources.

The middleware 143 may function as, for example, an intermediary for allowing the API 145 or the applications 147 to communicate with the kernel 141 to exchange data. Furthermore, the middleware 143 may process one or more task requests received from the applications 147 according to the priorities thereof. For example, the middleware 143 may assign, to at least one of the applications 147, a priority to use a system resource of the electronic device 101 (e.g., the bus 110, the processor 120, the memory 130, or the like), and may process the one or more task requests. The API 145 is an interface used by the application 147 to control a function provided from the kernel 141 or the middle ware 143, and may include, for example, at least one interface or function (e.g., an instruction) for file control, window control, image processing, text control, or the like. For example, the input/output interface 150 may forward commands or data, which is input from a user or an external device, to the other element(s) of the electronic device 101, or may output a command or data, which is received from the other element(s) of the electronic device 101, to the user or the external device.

The display 160 may include, for example, a liquid crystal display (LCD), a light emitting diode (LED) display, an organic light emitting diode (OLED) display, a micro electro mechanical system (MEMS) display, or an electronic paper display. The display 160 may display various pieces of content (e.g., text, images, videos, icons, and/or symbols) to a user. The display 160 may include a touch screen and may receive, for example, a touch, gesture, proximity, or hovering input using an electronic pen or a body part of a user. The communication interface 170, for example, may set up communication between the electronic device 101 and an external device (e.g., a first external electronic device 102, a second external electronic device 104, or a server 106). For example, the communication interface 170 may be connected to the network 162 via wireless communication or wired communication, and may communicate with an external device (e.g., the second external electronic device 104 or the server 106).

The wireless communication may include, for example, cellular communication that uses at least one of LTE, LTE-Advanced (LTE-A), code division multiple access (CDMA), wideband CDMA (WCDMA), universal mobile telecommunications system (UMTS), wireless broadband (WiBro), global system for mobile communications (GSM), or the like. According to an embodiment, the wireless communication may include, for example, at least one of Wi-Fi, Bluetooth, Bluetooth low energy (BLE), ZigBee, near field communication (NFC), magnetic secure transmission, radio frequency (RF), and body area network (BAN). According to an embodiment, the wireless communication may include a GNSS. The GNSS may be, for example, a global positioning system (GPS), a global navigation satellite system (Glonass), a Beidou navigation satellite system (hereinafter, referred to as “Beidou”), or Galileo (the European global satellite-based navigation system). Hereinafter, in this document, the term “GPS” may be interchangeable with the term “GNSS”. The wired communication may include, for example, at least one of a universal serial bus (USB), a high definition multimedia interface (HDMI), recommended standard 232 (RS-232), power line communication, a plain old telephone service (POTS), or the like.

The network 162 may include a telecommunication network, for example, at least one of a computer network (e.g., LAN or WAN), the Internet, and a telephone network.

Each of the first and second external electronic devices 102 and 104 may be of a type that is the same as, or different from, that of the electronic device 101. According to various embodiments, all or a part of operations executed in the electronic device 101 may be performed by another electronic device or a plurality of electronic devices (e.g., the electronic devices 102 and 104, or the server 106). According to an embodiment, when the electronic device 101 has to perform some functions or services automatically or in response to a request, the electronic device 101 may request another device (e.g., the electronic device 102 or 104 or the server 106) to perform at least some functions relating thereto, instead of, or in addition to, performing the functions or services by itself. Another electronic device (e.g., the electronic device 102 or 104, or the server 106) may perform the requested function or additional function, and transfer the result of performing the function to the electronic device 101. The electronic device 101 may provide the received result as it is, or may additionally process the received result to provide the requested functions or services. To this end, for example, cloud computing, distributed computing, or client-server computing technology may be used.

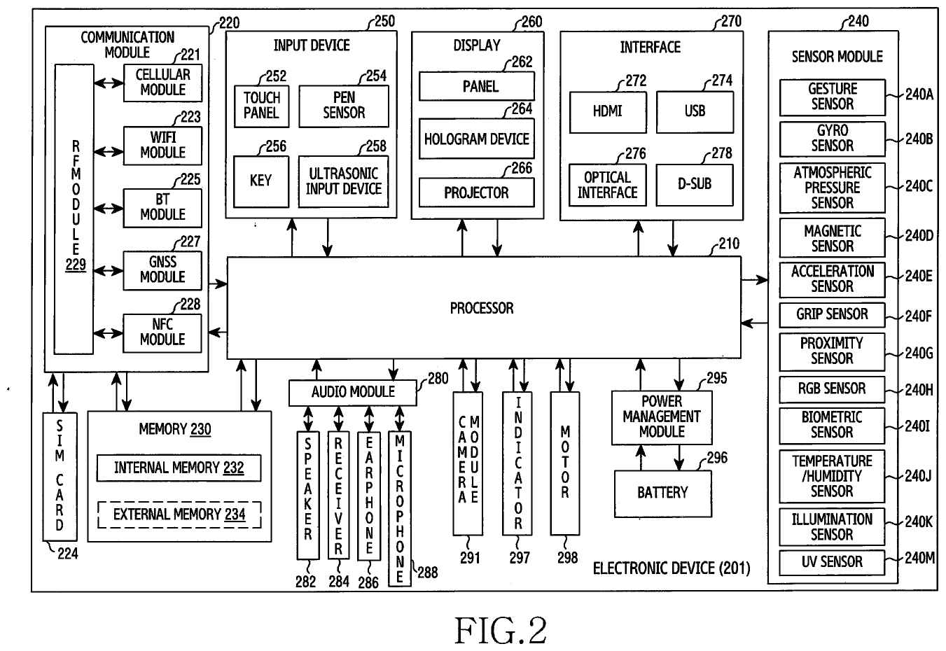

FIG. 2 is a block diagram of an electronic device 201 according to various embodiments.

The electronic device 201 may include, for example, the entirety or a part of the electronic device 101 illustrated in FIG. 1. The electronic device 201 may include one or more processors (e.g., AP) 210, a communication module 220, a subscriber identification module 224, a memory 230, a sensor module 240, an input device 250, a display 260, an interface 270, an audio module 280, a camera module 291, a power management module 295, a battery 296, an indicator 297, and a motor 298.

The processor 210 may control a plurality of hardware or software elements connected thereto and may perform various data processing and operations by driving an operating system or an application program. The processor 210 may be implemented as, for example, a system on chip (SoC). According to an embodiment, the processor 210 may further include a graphic processing unit (GPU) and/or an image signal processor. The processor 210 may include at least a part (e.g., a cellular module 221) of the elements illustrated in FIG. 2. The processor 210 loads commands or data received from the described other elements (e.g., non-volatile memory) in volatile memory, processes the commands or data, and stores resultant data in non-volatile memory.

The communication module 220 (e.g., the communication interface 170) may include, for example, the cellular module 221, a Wi-Fi module 223, a Bluetooth module 225, a GNSS module 227, an NFC module 228, and an RF module 229. The cellular module 221 may provide, for example, a voice call, a video call, a text message service, an Internet service, or the like via a communication network. According to an embodiment, the cellular module 221 may identify and authenticate the electronic device 201 in a communication network using a subscriber identification module (e.g., a SIM card) 224. According to an embodiment, the cellular module 221 may perform at least some of the functions that the processor 210 may provide. According to an embodiment, the cellular module 221 may include a communication processor (CP).

According to an embodiment, at least some (e.g., two or more) of the cellular module 221, the Wi-Fi module 223, the Bluetooth module 225, the GNSS module 227, or the NFC module 228 may be included in a single integrated chip (IC) or IC package. The RF module 229 may transmit and receive, for example, a communication signal (e.g., an RF signal). The RF module 229 may include, for example, a transceiver, a power amp module (PAM), a frequency filter, a low noise amplifier (LNA), an antenna, or the like. According to another embodiment, at least one of the cellular module 221, the Wi-Fi module 223, the Bluetooth module 225, the GNSS module 227, or the NFC module 228 may transmit or receive an RF signal via a separate RF module. The subscriber identification module 224 may include, for example, a card including a subscriber identification module or an embedded SIM, or may include unique identification information (e.g., integrated circuit card identifier (ICCID)) or subscriber information (e.g., an international mobile subscriber identity (IMSI)).

The memory 230 (e.g., the memory 130) may include, for example, an embedded memory 232 or an external memory 234. The embedded memory 232 may include, for example, at least one of volatile memory (e.g., DRAM, SRAM, SDRAM, or the like) and non-volatile memory (e.g., onetime programmable ROM (OTPROM), PROM, EPROM, EEPROM, mask ROM, flash ROM, flash memory, a hard drive, a solid state drive (SSD)). The external memory 234 may include a flash drive, for example, a compact flash (CF), a secure digital (SD), a micro-SD, a mini-SD, an extreme digital (xD), a multi-media card (MMC), a memory stick, and the like. The external memory 234 may be functionally or physically connected to the electronic device 201 via various interfaces.

The sensor module 240 may, for example, measure a physical quantity or may detect the operating state of the electronic device 201, and may convert the measured or detected information into an electrical signal. The sensor module 240 may include, for example, at least one of a gesture sensor 240A, a gyro sensor 240B, an atmospheric pressure sensor 240C, a magnetic sensor 240D, an acceleration sensor 240E, a grip sensor 240F, a proximity sensor 240G, a color sensor 240H (e.g., an Red, Green, and Blue (RGB) sensor), a biometric sensor 2401, a temperature/humidity sensor 240J, an illumination sensor 240K, or an ultraviolet (UV) sensor 240M. Additionally or alternatively, the sensor module 240 may include, for example, an e-nose sensor, an electromyography (EMG) sensor, an electroencephalogram (EEG) sensor, an electrocardiogram (ECG) sensor, an infrared (IR) sensor, an iris sensor, and/or a fingerprint sensor. The sensor module 240 may further include a control circuit for controlling one or more sensors included therein. In some embodiments, the electronic device 201 may further include a processor configured to control the sensor module 240 as a part of, or separately from, the process 210, and may control the sensor module 240 while the processor 210 is in a sleep state.

The input device 250 may include, for example, a touch panel 252, a (digital) pen sensor 254, a key 256, or an ultrasonic input device 258. The touch panel 252 may use, for example, at least one of a capacitive type, a resistive type, an infrared type, or an ultrasonic type. Furthermore, the touch panel 252 may further include a control circuit. The touch panel 252 may further include a tactile layer to provide a tactile reaction to a user. The (digital) pen sensor 254 may include, for example, a recognition sheet that is a part of, or separate from, the touch panel. The key 256 may include, for example, a physical button, an optical key, or a keypad. The ultrasonic input device 258 may detect ultrasound waves generated from an input device by using a microphone (e.g., the microphone 288), and identify data corresponding to the detected ultrasound waves.

The display 260 (e.g., the display 160) may include a panel 262, a hologram device 264, a projector 266, and/or a control circuit for controlling the same. The panel 262 may be implemented to be, for example, flexible, transparent, or wearable. The panel 262, together with the touch panel 252, may be configured as one or more modules. According to an embodiment, the panel 262 may include a pressure sensor (or a force sensor) which may measure a strength of pressure of a user's touch. The pressure sensor may be implemented to be integrated with the touch panel 252 or may be implemented as one or more sensors separate from the touch panel 252. The hologram device 264 may show a three-dimensional image in the air using light interference. The projector 266 may display an image by projecting light onto a screen. The screen may be located, for example, inside or outside the electronic device 201. The interface 270 may include, for example, an HDMI 272, a USB 274, an optical interface 276, or a D-subminiature (D-sub) 278. The interface 270 may be included in, for example, the communication interface 170 illustrated in FIG. 1. Additionally or alternatively, the interface 270 may include, for example, a mobile high-definition link (MHL) interface, a secure digital (SD) card/multi-media card (MMC) interface, or an infrared data association (IrDA) standard interface.

The audio module 280 may convert, for example, sound into an electrical signal, and vice versa. At least some elements of the audio module 280 may be included, for example, in the input/output interface 145 illustrated in FIG. 1. The audio module 280 may process sound information that is input or output via, for example, a speaker 282, a receiver 284, earphones 286, the microphone 288, or the like. The camera module 291 is a device for shooting an image or a video, and may include one or more image sensors (e.g., a front side sensor or a back side sensor), a lens, an image signal processor (ISP), or a flash (e.g., an LED or xenon lamp). The power management module 295 may manage, for example, the power of the electronic device 201. According to an embodiment, the power management module 295 may include a power management integrated circuit (PMIC), a charger IC, or a battery or fuel gauge. The PMIC may use a wired and/or wireless charging method. The wireless charging method may include, for example, a magnetic resonance method, a magnetic induction method, an electromagnetic wave method, or the like. Additional circuits (e.g., a coil loop, a resonance circuit, a rectifier, or the like) for wireless charging may be further included. A battery gauge may measure, for example, the amount of charge remaining in the battery 296 and a voltage, current, or temperature while charging. The battery 296 may include, for example, a rechargeable battery and/or a solar battery.

The indicator 297 may display a predetermined state of the electronic device 201 or a part of the electronic device 201 (e.g., the processor 210), such as a boot-up state, a message state, a charging state, or the like. The motor 298 may convert an electrical signal into a mechanical vibration and may generate a vibration, haptic effect, or the like. The electronic device 201 may include a mobile TV support device (e.g., a GPU) that can process media data according to a standard, such as digital multimedia broadcasting (DMB), digital video broadcasting (DVB), mediaFlo™, or the like. Each of the above-described elements described in the disclosure may be configured with one or more components, and the names of the corresponding elements may be different according to an electronic device type. In various embodiments, an electronic device (e.g., the electronic device 201) may omit some elements or may further include additional elements, or some of the elements of the electronic device may be combined with each other to configure one entity, wherein the entity may identically perform the functions of the corresponding elements prior to the combination.

The communication module 220 may communicate with the server.

The processor 210 may receive a key to unlock a door lock and a rule including a condition for using the key and an action to be performed when the condition is satisfied, from the server via the communication module 220, may receive an event occurring inside or outside the electronic device, and may perform the action on the basis of the event and the rule.

The event may occur by at least one of user information, ID information, location information, and time information of the electronic device. The time information may be received from the server.

The action may include a function of transmitting the key to the door lock or another electronic device or a function of deleting the key from the memory.

The event may occur by a user input, and the processor may transmit the key to another electronic device on the basis of the user input.

The processor may perform the action, and may use the result of performing the action as event information.

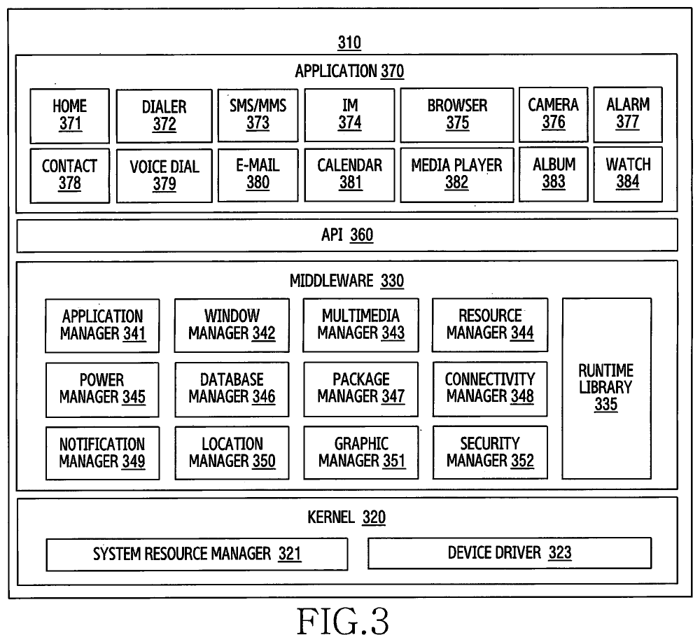

FIG. 3 is a block diagram of a program module according to various embodiments. According to an embodiment, a program module 310 (e.g., the program 140) may include an operating system that controls resources relating to an electronic device (e.g., the electronic device 101) and/or various applications (e.g., the application programs 147) that are driven on the operating system.

The operating system may include, for example, Android™, iOS™, Windows™, Symbian™, Tizen™, or Bada™. Referring to FIG. 3, the program module 310 may include a kernel 320 (e.g., the kernel 141), middleware 330 (e.g., the middleware 143), an API 360 (e.g., the API 145), and/or applications 370 (e.g., the application programs 147). At least part of the program module 310 may be preloaded on the electronic device, or may be downloaded from an external electronic device (e.g., the electronic device 102 or 104, or the server 106).

The kernel 320 may include, for example, a system resource manager 321 and/or a device driver 323. The system resource manager 321 may control, assign, or retrieve system resources. According to an embodiment of the disclosure, the system resource manager 321 may include a process manager, a memory manager, a file system manager, or the like. The device driver 323 may include, for example, a display driver, a camera driver, a Bluetooth driver, a shared memory driver, a USB driver, a keypad driver, a Wi-Fi driver, an audio driver, or an inter-process communication (IPC) driver. The middleware 330 may provide, for example, a function required by the applications 370 in common, or may provide various functions to the applications 370 via the API 360 so that the applications 370 can use limited system resources within the electronic device. According to an embodiment, the middleware 330 may include at least one of a runtime library 335, an application manager 341, a window manager 342, a multi-media manager 343, a resource manager 344, a power manager 345, a database manager 346, a package manager 347, a connectivity manager 348, a notification manager 349, a location manager 350, a graphic manager 351, and a security manager 352.

The runtime library 335 may include, for example, a library module that a compiler uses in order to add a new function via a programming language while the applications 370 are being executed. The runtime library 335 may manage input/output, manage memory, or process an arithmetic function. The application manager 341 may manage, for example, the life cycle of the application 370. The window manager 342 may manage GUI resources used for a screen. The multimedia manager 343 may identify formats required for reproducing various media files and may encode or decode a media file using a codec suitable for the corresponding format.

The resource manager 344 may manage the source codes of the applications 370 or the space of memory. The power manager 345 may manage, for example, the capacity or power of a battery, and may provide power information required for operating an electronic device. According to an embodiment, the power manager 345 may interoperate with a basic input/output system (BIOS). The database manager 346 may, for example, generate, search, or change databases to be used by the application 370. The package manager 347 may manage the installation or updating of an application that is distributed in the form of a package file.

The connectivity manager 348 may manage, for example, wireless connection. The notification manager 349 may provide an event to a user, for example, an arrival message, an appointment, a proximity notification, and the like. The location manager 350 may manage, for example, the location information of the electronic device. The graphic manager 351 may manage a graphic effect to be provided to a user and a user interface relating to the graphic effect. The security manager 352 may provide, for example, system security or user authentication. According to an embodiment, the middleware 330 may include a telephony manager for managing a voice or video call function of the electronic device or a middleware module that is capable of making a combination of the functions of the above-described elements. According to an embodiment, the middleware 330 may provide a module specialized for each type of operation system. Also, the middleware 330 may dynamically delete some of the existing elements, or may add new elements. The API 360 is, for example, a set of API programming functions, and may be provided in different configurations depending on an operating system. For example, in the case of Android or iOS, one API set may be provided for each platform, and in the case of Tizen, two or more API sets may be provided for each platform.

The applications 370 may include applications that provide, for example, home 371, a dialer 372, SMS/MMS 373, instant messaging (IM) 374, a browser 375, a camera 376, an alarm 377, contacts 378, a voice dial 379, an e-mail 380, a calendar 381, a media player 382, an album 383, a watch 384, health care (e.g., measuring exercise quantity or blood glucose), environment information (e.g., atmospheric pressure, humidity, or temperature information), and the like. According to an embodiment, the applications 370 may include an information exchange application that can support exchanging of information between the electronic device and an external electronic device. The information exchange application may include, for example, a notification relay application for relaying predetermined information to an external electronic device, or a device management application for managing an external electronic device. For example, the notification relay application may relay notification information generated in another application of the electronic device to an external electronic device, or may receive notification information from an external electronic device to provide the received notification information to a user. The device management application, for example, may install, delete, or update functions of an external electronic device that communicates with the electronic device (e.g., turning on/off the external electronic device itself (or some elements thereof) or adjusting the brightness (or resolution) of a display) or applications executed in the external electronic device. According to an embodiment, the applications 370 may include applications (e.g., a healthcare application of a mobile medical appliance) that are designated according to the attributes of an external electronic device. According to an embodiment, the applications 370 may include applications received from an external electronic device. At least part of the program module 310 may be implemented (e.g., executed) as software, firmware, hardware (e.g., the processor 210) or a combination of two or more thereof, and may include a module, a program, a routine, an instruction set, or a process for performing one or more functions.

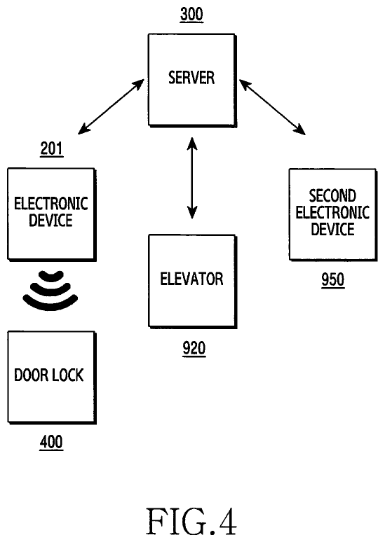

FIG. 4 is a diagram illustrating an example in which a server and an electronic device issue, delete, and transmit a key on the basis of a rule according to various embodiments.

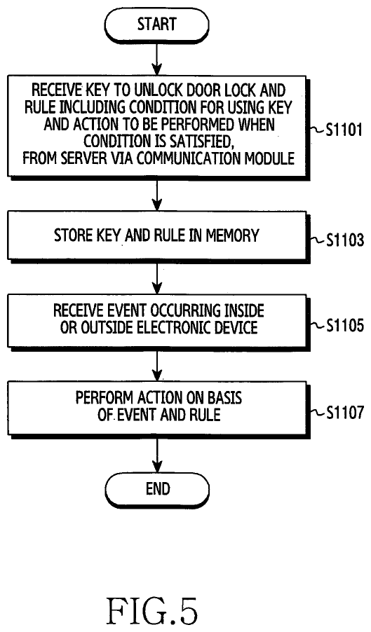

FIG. 5 is a flowchart illustrating a process in which an electronic device receives a rule from a server, and performs various actions on the basis of a rule according to various embodiments.

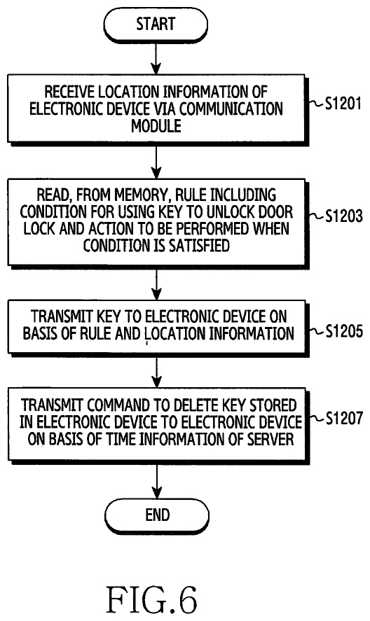

FIG. 6 is a flowchart illustrating a process in which a server deletes a key on the basis of a rule according to various embodiments.

Hereinafter, referring to FIGS. 4 to 6, an example in which a server and an electronic device issue, delete, and transmit a key will be described.

The server receives location information of the electronic device via a communication module in operation S1101.

A server 300 may read a rule from a memory on the basis of the received location information of the electronic device, and may perform an action according to a condition defined in the rule.

That is, the server 300 may be triggered by the location information received from the electronic device 201, and may read, from the memory, a rule including a condition for using a key to unlock a door lock and an action to be performed when the condition is satisfied in operation S1103.

The rule may be generated by a user input of a server manager or the electronic device. That is, the rule may be generated on the basis of information input by a user or information input by the server manager. For example, when a user makes a reservation for a room at a hotel via a website provided by the hotel, check-in time and check-out time of the hotel that the user inputs may be used as a condition for a rule. An operation, by the server, of issuing or deleting a key to unlock the door lock of the room that the user books may be the action of the rule. The server manager may be a hotel staff.

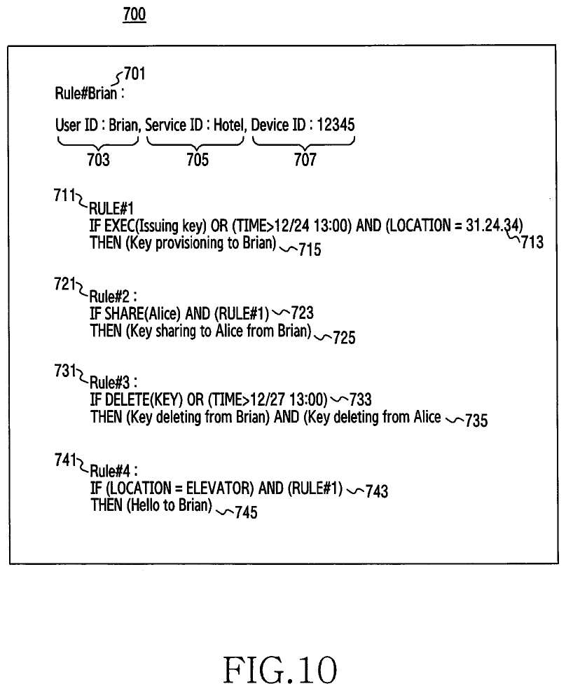

The server manager may generate the basic structure of a rule in advance, and a rule for a predetermined user may be generated by adding information input by the user to the basic rule. Examples of a rule will be described in detail with reference to FIG. 10.

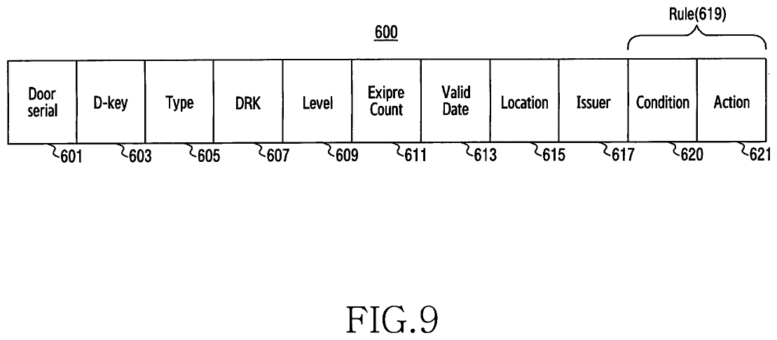

A key may include credentials. The credentials may include information for certifying qualification which is normally used in information technology or encryption technology, that is, an ID/password, an encryption key, biometric authentication information (fingerprint, iris, heartbeat), a certification (e.g., X.509), and the like. A key may include a rule. When a key includes a rule, the rule may be composed of some fields of the key. The structure of a key including a rule will be described in detail with reference to FIG. 9.

That is, a key may include credentials and/or a rule.

Depending on an embodiment, a key may further include additional information.

The server may transmit the key to the electronic device on the basis of the rule and the location information in operation S1105.

The fact that the server 300 issues a key may indicate that the server transmits the key to the electronic device 201. Also, the rule may include a condition for issuing the key. For example, when a user carrying the electronic device 201 arrives at a predetermined region (e.g., a hotel lobby), the server 300 recognizes that the user enters the hotel on the basis of the location information of the electronic device 201 and issues a key to the electronic device 201.

The electronic device 201 may store the issued key in a memory. When a rule is included in the key, the electronic device 201 may separate the rule from the key and store the same in the memory. Depending on an embodiment, the rule may be transmitted from the server, irrespective of the key. The electronic device 201 may receive the rule and may store the same in the memory.

The server 300 may continuously receive location information from the electronic device, and the server may perform different actions depending on a condition defined in the rule. For example, when the user moves to an elevator, the server may perform control such that a monitor installed in an elevator 920 displays a welcome message.

The server transmits, to the electronic device, a command to delete the key stored in the electronic device on the basis of time information in operation S1107.

For example, when the check-out time for the user elapses, the server transmits a command to delete the key to the electronic device of the user, and may delete the key from the memory of the electronic device 201, or may disable the key so that the key is incapable of unlocking a door lock 400. According to an embodiment, the key may include an effective period (check-out time). In this instance, on the basis of the effective period information included in the key, the electronic device 201 may delete the key from the memory or may disable the key so that the key is incapable of unlocking a door lock.

The electronic device 201 may receive a key to unlock a door lock and a rule including a condition for using the key and an action to be performed when the condition is satisfied, from a server via a communication module in operation S1201.

The electronic device may store the received key and rule in a memory in operation S1203.

The key may include the rule. Particularly, some of data in the key may include information associated with the rule. In this instance, the electronic device may parse the received key so as to extract the rule, and may store the same in the memory. In some embodiments, the key and the rule may be separately transmitted.

The electronic device may receive an event occurring inside or outside the electronic device in operation S1205.

The electronic device may be triggered by the event occurring inside or outside the electronic device, and read the rule stored in the memory and process the rule. In this instance, an action to be performed may be different for each event. An event inside the electronic device may occur on the basis of location information of the electronic device, time information, posture information, context information, and a signal output from a sensor module. For example, when the electronic device is located in a predetermined location or a predetermined time comes, an event may occur in the electronic device.

The time information may be time information inside the electronic device or may be received from the server. For example, when the hotel check-out time comes, the server transmits time information to the electronic device, and an event may occur in the electronic device. Alternatively, when the hotel check-out time comes, an event may occur in the electronic device using time information of the electronic device.

An event outside the electronic device may occur when a call or a text message is received from the outside. In addition, an event may occur by a user input.

The electronic device 201 may perform an action on the basis of the event and,the rule in operation S1207.

When an event occurs, the electronic device 201 may compare the event and a condition included in the rule. When the condition is satisfied, the electronic device may perform an action corresponding thereto. For example, when the electronic device 201 is in contact with the door lock 400, an NFC event may occur via a communication module, and the electronic device 201 may perform an action of transmitting a key to the door lock 400, as defined in the rule.

Also, when an event occurs, and the event satisfies a condition included in the rule, the electronic device may transmit a key to another electronic device and may share the key with the other electronic device. For example, when a user inputs, using the electronic device, information associated with a second user (e.g., a phone number) with whom the key is to be shared, the second user information may be transmitted to the server 300. When the second user requests issuing of a key, the server 300 may issue a key to a second electronic device 950 used by the second user.

Also, when an event occurs and the event satisfies a condition included in the rule, the electronic device may delete a key from the memory of the electronic device.

The electronic device may perform an action, and may use information associated with the result of performing the action as condition data for performing the rule.

Also, the electronic device may perform an action, and may use information associated with the result of performing the action as data for generating an event.

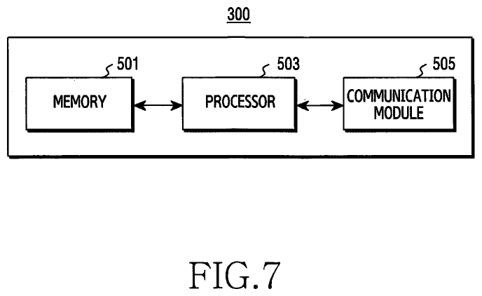

FIG. 7 is a block diagram of a server according to various embodiments.

The server may include a memory 501, a processor 503, and a communication module 505.

The memory 501 may store a key to unlock a door lock, and a rule.

The rule may include a condition for using the key and an action to be performed when the condition is satisfied.

The communication module 505 may communicate with an electronic device, and the server 300 may transmit a key and, a rule to an electronic device via the communication module.

The processor 503 may be electrically connected to the memory 501 and the communication module 505, may receive location information of an electronic device via the communication module 505, may read a rule from the memory 501, and may transmit a key to the electronic device on the basis of the location information and the rule.

The structure of a rule will be described in detail with reference to FIG. 10.

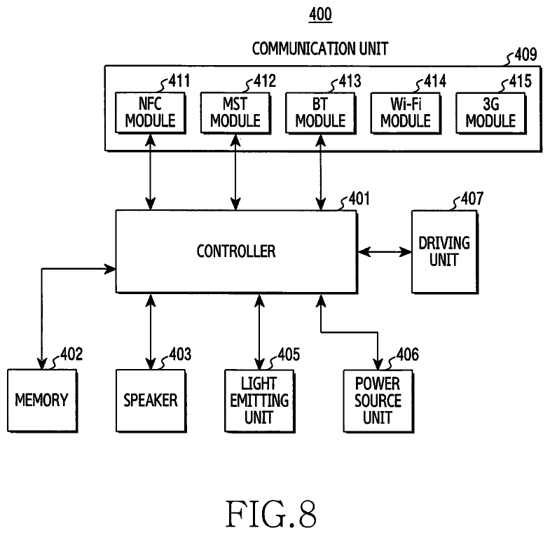

FIG. 8 is a block diagram of a door lock according to various embodiments.

Referring to FIG. 8, the door lock 400 may include a controller 401, a communication unit 409, a driving unit 407, a speaker 403, an LED 405, and a power source unit 406.

The communication unit 409 may include an NFC module 411, an MST module 412, a Bluetooth module 413, a Wi-Fi module 414, and a 3G module 415.

The door lock 400 may receive a key to perform unlocking from an electronic device via the communication unit 409. The door lock may receive the key from the electronic device using a near-field communication module (e.g., the NFC module 411, the MST module 412, and the Bluetooth module 413). The key may be encrypted and transmitted from the electronic device.

According to an embodiment, the door lock 400 may receive a key from the server via the mobile communication network 415.

The door lock has unique credentials capable of unlocking the door lock, and the credentials may be given by a manufacturer when the door lock is manufactured. Also, a door lock which has a communication function may be assigned with credentials via the server. The door lock may be installed in the gate of a house, a building, and an office, and may be also installed in a vehicle (e.g., a car door, a car boot, or the like).

The credentials may be included in the key transmitted by the electronic device. Referring to FIG. 9, a key 600 may include credentials 603. Also, the key 600 may include a rule 619. A “key” used in the document may be understood as a key for turning on the ignition of a car, a virtual key for operating an electronic device, and an authentication means including a virtual key for financial transaction, in addition to a key for unlocking a door lock.

The driving unit 407 may drive a locking device using a motor or an electromagnet, so as to operate in an unlocked state or locked state.

When the door lock 400 is normally unlocked, the speaker 403 may output sound determined in advance by the controller.

When the door lock 400 is normally unlocked, a light emitting unit (e.g., an LED) may emit light with a pattern or color determined in advance by the controller.

The power source unit 406 (e.g., a battery) may supply power to the door lock 400.

Credential data capable of unlocking the door lock 400 may be stored in the memory 402. The credential data may be generated by a manufacturer when the door lock is manufactured, and may be stored in the memory 402.

According to an embodiment, credential data may be transmitted from a server.

Hereinafter, for ease of description, the credential data stored in the memory 402 of the door lock may be referred to as first credential data, and the credential data transmitted from the electronic device may be referred to as second credential data.

The controller 401 may control the communication unit 409, the driving unit 407, the memory 402, the speaker 403, and the light emitting unit 405, so as to lock or unlock the door lock 400.

For example, when a key is transmitted from an electronic device, the door lock 400 may receive the key via the communication unit, may extract second credential data from the received key, and may compare the second credential data with the first credential data stored in the memory. When the result of the comparison shows that the first credential data and the second credential data are identical to each other, the controller 401 may control the driving unit 407 so as to unlock the locking device of the door lock 400.

When the door lock 400 is normally unlocked, the controller 401 may control the speaker to output a predetermined sound.

Alternatively, when the door lock 400 is normally unlocked, the controller 401 may control the light emitting unit to emit light with a predetermined pattern or a predetermined color.

Alternatively, when the door lock 400 is normally unlocked, the controller 401 may control the Bluetooth module 413 so as to transmit data corresponding to successful unlocking to the electronic device.

In various embodiments, the door lock 400 may omit some elements or may further include additional elements, or some of the elements of the door lock 400 may be coupled to each other to configure one entity, wherein the entity may perform the identical functions of the corresponding elements prior to the coupling.

FIG. 9 is a diagram illustrating the structure of a key that a server transmits to an electronic device according to various embodiments.

Referring to FIG. 6, the key 600 may include a plurality of data fields 601 to 617. According to an embodiment, the key 600 may further include data fields 620 and 621. The data fields 620 and 621 may be a rule 619 including a condition 620 for using the key and an action 621.

The field 601 may be the serial number of a door. The serial number may be designated by a user or may be provided by a door lock manufacturer.

A field 603 is credentials capable of unlocking a door lock. That is, it may be a unique number for unlocking the locked state of the door lock.

A field 605 may indicate a type of key. The type may be data for indicating whether a door is installed at a fixed location, such as a front door, or whether a door is movable such as a car door or a car boot. Also, the type may be data indicating a key for operating a predetermined device, such as turning on the ignition of a car.

The electronic device may determine whether to sequentially transmit a plurality of keys to a door lock, on the basis of the field 605. For example, when the type is “1”, the electronic device may determine that the key is a key used for the main entrance of an apartment building. In this instance, the electronic device may extract a plurality of keys stored in the memory on the basis of location information, and may sequentially transmit the plurality of extracted keys to the main entrance.

When the type is “2”, the electronic device determines that the key is a key for the front door of a house. In this instance, in order to prevent the key from being hooked, the electronic device may not sequentially transmit a plurality of keys.

Also, the electronic device may determine whether to use location information on the basis of the field 605. For example, when the field 605 is “3”, the electronic device may extract a plurality of keys from the memory on the basis of location information, and sequentially transmit the plurality of extracted keys to the door lock. When the field 605 is “4”, the electronic device may not use location information.

A field 609 may be data indicating the level of authority of a key. For example, unlocking a car door and a car boot, and turning on the ignition of a car may be performed using a single key, like the case of a car. In this instance, when the value of the field 609 is “1”, unlocking a car boot is available. When the value is “2”, unlocking a car door and a car boot is available. When the value is “3”, unlocking a car door and a car boot, and turning on the ignition of a car are available.

A field 611 may be data indicating the number of times that a key can be used. For example, when the value of the field 611 is “5”, the key may be used a total of five times.

A field 613 may be data indicating an effective period during which a key is available. A field 613 may be a date or a duration (a period of time). According to an embodiment, the field 613 may include check-out time information of a user.

For example, when the value of the field 613 is “20161231”, the key may be available until Dec. 31, 2016, and may become disabled after Dec. 31, 2016. Alternatively, when the value of the field 613 is “24 hours”, the key is available during 24 hours after the key is issued.

A field 615 may be location information indicating a location in which a key is available. For example, in the case of a hotel, the field 615 may be location information associated with a predetermined room.

The electronic device 100 may or may not transmit a key to the door lock 400 on the basis of location information included in the field 615.

For example, when the location information of the field 615 indicates location A, the electronic device is capable of unlocking a door lock when the electronic device exists in location A. However, the electronic device is incapable of unlocking a door lock using the same key when the electronic device exists at location B.

A field 617 may include information associated with an issuer that issues a key. For example, information associated with a company that manufactures a door lock may be included.

According to various embodiments, the fields included in the key 600 may omit some elements or may further include additional elements, or some of the elements may be combined with each other to configure one entity.

According to various embodiments, the use of the fields included in the key 600 may be restricted or disregarded according to a rule. For example, the electronic device may preferentially utilize a condition included in a rule, and in this instance, the electronic device may not use data fields included in a key.

FIG. 10 is a diagram illustrating the structure of a rule set according to various embodiments.

A rule set 700 may be a set of a plurality of rules, and may include a unique name 701. The unique name 701 may be used for identifying the rule set 700. The unique name 701 may be the name of a predetermined user to whom the rule set 700 is applied. For example, the unique name 701 may be the same as a user ID or a device ID of an electronic device that executes the rule set 700.

The rule set 700 may include identification items 703, 705, and 707.

The identification items may include a user ID 703, a service

ID 705, and/or a device ID 707.

The user ID 703 may be information associated with a user to whom the rule set 700 may be applied.

The service ID 705 may be information associated with a service that the rule set 700 provides.

The device ID 707 may be information associated with an electronic device to which the rule set 700 is applied.

Rules 711, 721, 731, and 741 may include conditions and actions to be performed when conditions are satisfied.

The rule set 700 may be stored in a server or an electronic device.

The rule set 700 may omit some elements or may further include additional elements depending on various embodiments.

Hereinafter, the structure of the rule set 700 and an example in which the electronic device processes the rule set 700 will be described from the perspective of a service provided in a hotel.

The rule set 700 is associated with a service provided from a hotel, and may be applied to user 1 (e.g., Brian) 703 and an electronic device (12345) 707 of user 1.

Rule #1 includes a condition 713 and an action 715.

The condition 713 is to determine whether the electronic device of user 1 exists at location “31.24.34” after 13:00 on December 24. For example, under the assumption that the hotel is located at location “31.24.34”, when user 1 carries the electronic device and enters the hotel after 13:00 on December 24, a server performs the action 715 and issues a key to user 1. That is, the server transmits the key to the electronic device of user 1.

Rule #2 721 includes a condition 713 and an action 715.

The condition 723 may include a result of performing rule #1 723. That is, the result of performing rule #1 711 may be used as a condition for rule #2 721. According to the condition 723, the server performs rule #1 711, and when a user ID (e.g., Alice) with whom a key is to be shared is input, the server performs an action of transmitting the key to user 2 (e.g., Alice) to share the key.

Rule #3 731 includes a condition 733 and an action 735.

The condition 733 is to determine whether the current time is before or after 13:00 on December 27, and the action 735 is to delete the keys for user 1 and user 2. After 13:00 on Dec. 27, the server may transmit a command to delete the key to the electronic device of user 1 and the electronic device of user 2, and thus, the electronic device of user 1 and the electronic device of user 2 may delete their keys.

Rule #4 741 includes a condition 743 and an action 745.

The condition 743 is to determine whether a user is located in an elevator and rule #1 is executed, and the action 745 is to transmit a welcome message to user 1 when the condition 743 is satisfied.

That is, when the user 1 is assigned with a key and moves to an elevator, the server may transmit a welcome message to the electronic device of user 1 or the monitor of the elevator. According to an embodiment, the room number of user 1 may be displayed on the monitor.

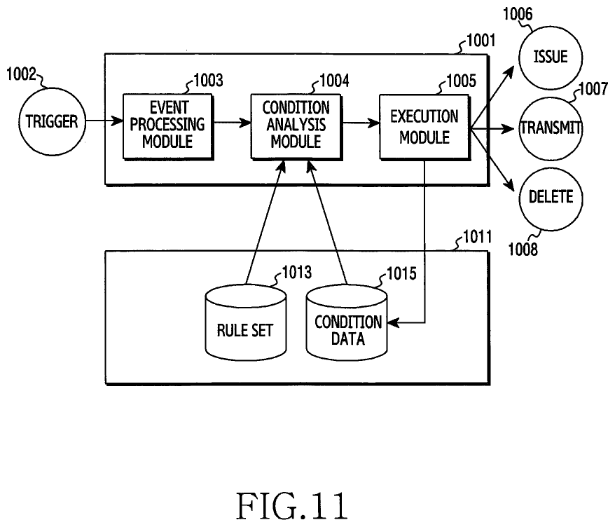

FIG. 11 is a block diagram of a rule engine that processes a rule in an electronic device according to various embodiments.

Referring to FIG. 11, a rule engine 1000 may include an event processing module 1003, a condition analysis module 1004, an execution module 1005, a rule set 1013, and condition data 1015.

In the rule engine 1000, the event processing module 1003, the condition analysis module 1004, and the execution module 1005 may be implemented as a software module 1001, may be stored in a memory 1011 in the form of a program, and may be loaded in the processor 1001 when being executed.

The rule set 1013 and the condition data 1015 may be stored in the memory 1011.

The processor 1001 and the memory 1011 may be elements of a server or an electronic device.

The event processing module 1003 may be triggered 1002 when an event occurs, and may process input data so as to convert the same into information that the processor can process.

When a condition defined in the rule set 1013 is input, the condition analysis module 1004 may determine a function (e.g., issuing, transmission, or deletion of a key) to be performed, may determine when the function is to be performed, and may determine a device (e.g., a server, an electronic device, a second electronic device, a door lock, or the like) in which the function is to be performed.

The execution module 1005 may perform issuing 1006, transmission 1007, and deletion 1008 of a key. Also, the execution module 1005 may update condition data 1015. The result of execution by the execution module 1005 may function as an event of another rule, and may be used as the trigger 1002.

The rule set 1013 is a set of a plurality of rules. The processor 100 may process a rule in the rule set 1013 stored in the memory 1011, may compare a condition included in the rule, a condition input via the event processing module 1003, and condition data 1015, and may provide the processing result to the execution module 1005. The execution module 1005 may perform issuing 1006, transmission 1007, and deletion 1008 of a key depending on the processing result.

Referring to FIG. 10, when the processor 1001 processes rule #1 711, time information of the server or the electronic device and the location information of the electronic device may be input as the trigger 1002. When it is assumed that the time information is “13:10 on December 24”, and the location information of the electronic device is “31.24.34”, the event processing module 1003 may extract the time information “13:10 on December 24” and the location information “'31.24.34”, and may transmit the same to the condition analysis module 1004.

The condition analysis module 1004 may compare the condition 713 defined in rule #1 711 and the data obtained via the event processing module 1003, and since the result satisfies a comparison result condition, the execution module 1005 issues a key to user 1 according to the action 715 defined in rule #1 711.

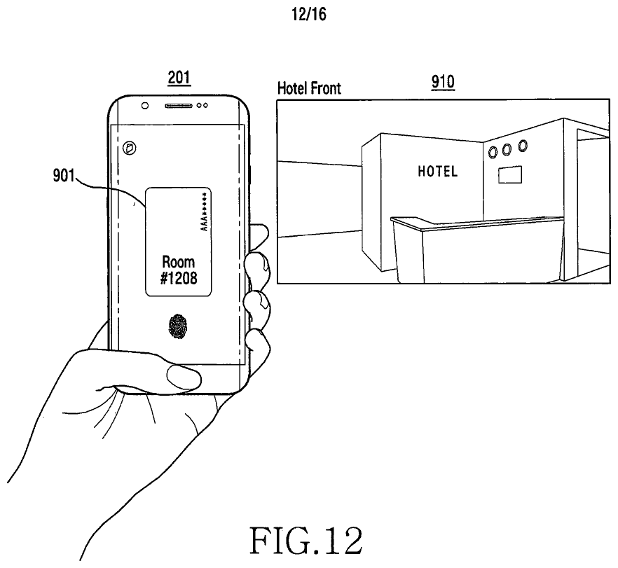

FIG. 12 is a diagram illustrating an example in which a server issues a key to a user on the basis of a rule and location information of the user.

FIG. 12 illustrates the electronic device 201 and the server 300.

For ease of description, an embodiment will be described with reference to FIG. 12 together with FIG. 10.

For example, if user 1 makes a reservation for a room at a hotel from December 24 to 27 using the electronic device 201, the server 300 may generate the rule set 700 illustrated in FIG. 10 using the reservation information of user 1.

The server 300 may add a user ID and a device ID to the rule set 700 using the user information and electronic device information input by user 1. Also, the server 300 may generate a service ID and may add the same to the rule set 700.

The server 300 may generate a rule using the check-in date “December 24” and the check-out date “December 27” that user 1 inputs.

When user 1 enters a corresponding hotel 910, the location information of the electronic device 201 is transmitted to the server 300, and the server 300 may receive the location information of the electronic device 201, may be triggered by the received location information so as to read a rule set stored in a memory, and may process rule #1 711.

The server 300 may transmit a key and a rule set to user 1 on the basis of location information and time information included in the condition 713 of rule #1. The electronic device 201 may receive the key that the server 300 transmits, may display a key 901 in the electronic device 201, and may report that the key 901 is issued. The key 901 displayed in the electronic device 201 may be an image in the form of a card, but the disclosure is not limited thereto. According to an embodiment, the effective period of the key 901 may be displayed in the electronic device.

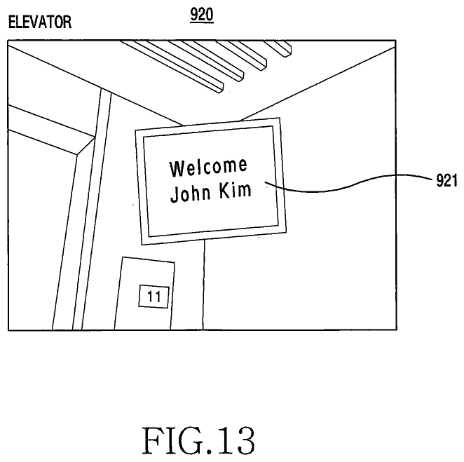

FIG. 13 is a diagram illustrating an example in which a server transmits a message on the basis of a rule and location information of an electronic device according to various embodiments.

Referring to FIGS. 13 and 10, when a user moves to an elevator, the server may recognize that the user is on the elevator on the basis of location information transmitted from the electronic device 201. The server 300 may be triggered by the location information of the electronic device, may process rule #4 741 related thereto, and may display a predetermined message 921 on a monitor of the elevator. The message 921 may include words of welcome.

According to an embodiment, the monitor installed in the elevator may communicate with the electronic device 201. In this instance, the monitor determines that the user enters the elevator, and may transmit information related to the electronic device to the server.

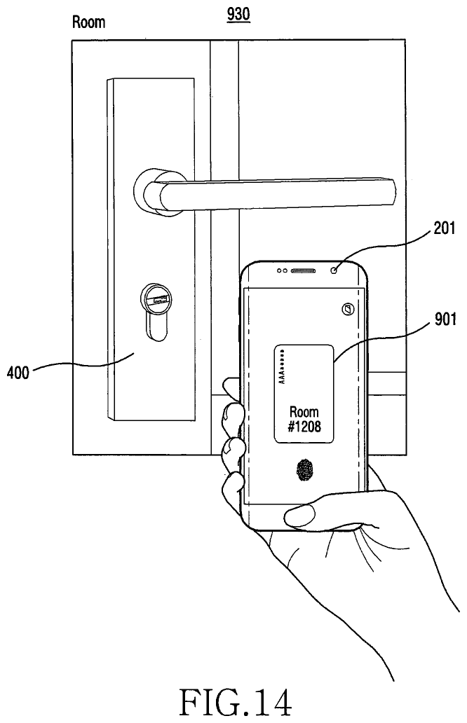

FIG. 14 is a diagram illustrating an example in which an electronic device transmits a key to a door lock on the basis of a rule according to various embodiments.

Referring to FIGS. 14 and 10, when a user arrives at a room and brings the electronic device 201 into contact with the door lock 400, NFC tag information is received. The electronic device is triggered by the received NFC tag information, and reads a rule set stored in the electronic device.

The electronic device 201 may process a rule related to the NFC tag information, and may transmit credential data of a key to the door lock 400 according to the processing result, so as to unlock the door lock.

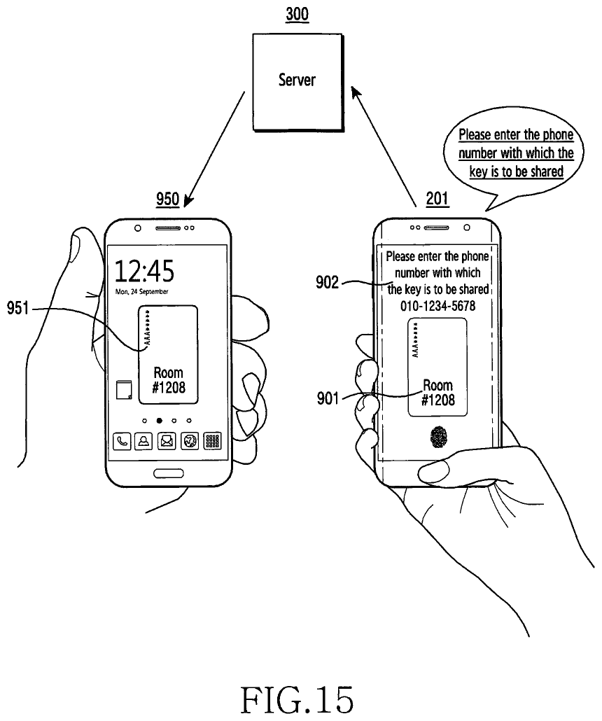

FIG. 15 is a diagram illustrating an example in which an electronic device shares a key with a second electronic device on the basis of a rule according to various embodiments.

Referring to FIGS. 15 and 10, the electronic device 201, the server 300, and the second electronic device 950 are illustrated.

When a user runs a key sharing app (not illustrated) in the electronic device 201 so as to transmit the key 901 to the second electronic device 950 (an electronic device of another user), the electronic device 201 may be triggered by a command to run the key sharing app (not illustrated), and may process rule #2 721.

For example, when a user touches the key 901 displayed in the electronic device 201, the key sharing app (not illustrated) runs and a user interface 902 which requires information (e.g., a phone number, an email address, or the like) associated with a partner with whom the key 901 is to be shared may be displayed on a screen.

When the key sharing app 902 runs, rule #2 721 is processed. When user information associated with a user with whom the key is to be shared is input, the condition 723 is satisfied, and the action 725 is executed. For example, when the user inputs a partner's phone number, the phone number is transferred to the server 300, and the server 300 may process the phone number using rule #2 721.

The server may transmit a key 951 to the electronic device 950 corresponding to the received phone number so as to share the key 901.

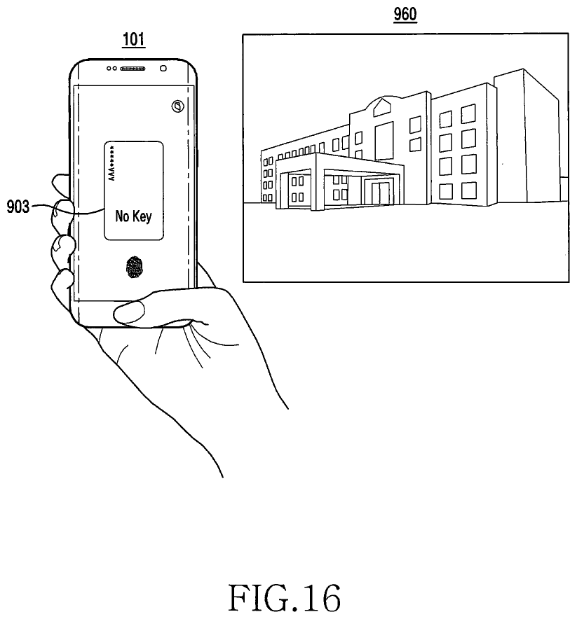

FIG. 16 is a diagram illustrating an example in which a server deletes a key stored in an electronic device according to various embodiments.

Referring to FIGS. 16 and 10, the electronic device 201 and the server 300 are illustrated.

The server 300 may be triggered by time information and may process rule #3 731.

For example, when the current time is close to “13:00 on December 27”, the server 300 may transmit a warning message (e.g., “one hour left until the check-out time”) to the electronic device 201 of a user.

The server 300 compares the current time with the condition 733 of rule #3 731, and may perform action 735 when the comparison result shows that the current time is past 13:00 on December 27. Accordingly, the server 300 may transmit a command to delete a stored key to the electronic device 201 and the electronic device 950 of another user.

When the action 735 is performed, the electronic device 201 of the user may display a user interface 903 indicating that no key exists.

An electronic device according to various embodiments may issue, transmit, and delete a key using a rule stored in a memory, and may systematically and simply manage the life cycle from issuing and deleting a key.

As used herein, the term “module” may include a unit implemented in hardware, software, or firmware, and may interchangeably be used with other terms, for example, “logic,” “logic block,” “part,” or “circuitry”. The “module” may be a single integral component, or a minimum unit or part thereof, adapted to perform one or more functions. The “module” may be implemented mechanically or electronically, and may include, for example, at least one of an application-specific integrated circuit (ASIC) chip, a field-programmable gate array (FPGA), and a programmable-logic device for performing some operations, which are known or will be developed.

According to various embodiments, at least some of the devices (for example, modules or functions thereof) or the method (for example, operations) according to the disclosure may be implemented by a command stored in a computer-readable storage medium in a programming module form. When the command is executed by processors, the processors may perform a function corresponding to the command.

Here, a program is stored in a computer-readable non-transitory recording medium, and is read and executed by a computer, whereby embodiments of the disclosure are implemented.

Here, the non-transitory recording medium indicates a medium that semi-permanently stores data, and is readable by a device, and may include volatile or non-volatile memory that temporarily store data to be calculated or transmitted, such as a register, cache, buffer, or the like.

Conversely, a transitory transmission medium such as a signal, current or the like does not belong to the non-transitory recording medium.

Particularly, the above-described programs may be provided by being stored in a non-transitory readable recording medium such as a CD, DVD, a hard disk, a blue ray disk, a USB, embedded memory, a memory card, ROM or RAM, or the like.

Also, the above-described programs may be stored in memory of a server, and may be transmitted to a terminal (e.g., a device in the disclosure) connected to the server over a network for sale, or may be transferred to or may be registered with the server by a program provider (e.g., a developer or manufacturer of the program). Also, when a terminal purchases the above-described programs from the server, at least some of the programs may be temporarily generated in a buffer of the server for transmission. In this instance, the buffer of the server may be a non-transitory recording medium of the disclosure.

According to an embodiment, a computer-readable non-transitory recording medium may store programs that enable an electronic device of the disclosure to perform operations, the operations including: an operation of determining a data provision time interval which is a time interval at which each of a plurality of pieces of data of streaming content is provided to a streaming application via a proxy module; an operation of downloading first data, which is a part of the streaming content, from an external device, and storing the same; and an operation of providing stored first data to the streaming application via the proxy module at the determined data provision time intervals, when the streaming application requests the first data.

The programming module according to the disclosure may include one or more of the aforementioned components or may further include other additional components, or some of the aforementioned components may be omitted. Operations performed by a module, a programming module, or other elements according to various embodiments may be executed sequentially, in parallel, repeatedly, or in a heuristic manner. At least some operations may be executed according to another sequence, may be omitted, or may further include other operations.

1. An electronic device, comprising:
a memory;
a communication module configured to communicate with a server; and
a processor configured to be electrically connected to the memory and the communication module,
wherein the processor is configured to:
receive a key to unlock a door lock and a rule comprising a condition for using the key and an action to be performed when the condition is satisfied, from the server via the communication module, and store the key and the rule in the memory; and
when an event occurs inside or outside the electronic device, perform the action on the basis of the event and the rule.

2. The electronic device of claim 1, wherein the event occurs on the basis of at least one of user information, ID information, location information, and time information of the electronic device.

3. The electronic device of claim 2, wherein the time information is received from the server.

4. The electronic device of claim 1, wherein the action comprises a function of transmitting the key to the door lock or another electronic device, or a function of deleting the key from the memory.

5. The electronic device of claim 4, wherein the event occurs on the basis of a user input, and the processor transmits the key to another electronic device on the basis of the user input.

6. The electronic device of claim 1, wherein the processor performs the action, and uses information associated with a result of performing the action as condition data for performing the rule.

7. The electronic device of claim 1, wherein the processor performs the action, and uses information associated with a result of performing the action as data that generates the event.

8. The electronic device of claim 1, wherein the key comprises the rule.

9. A server, comprising:
a memory configured to store a key to unlock a door lock, and a rule comprising a condition for using the key and an action to be performed when the condition is satisfied;
a communication module configured to communicate with an electronic device;
a processor configured to be electrically connected to the memory and the communication module,
wherein the processor is configured to:
receive location information of the electronic device via the communication module, and read the rule from the memory; and
transmit the key to the electronic device on the basis of the location information and the rule.

10. The server of claim 9, wherein the processor transmits, to the electronic device, a command to delete the key stored in the electronic device on the basis of time information of the server.

11. A method of unlocking a door lock by an electronic device, the method comprising:
receiving a key to unlock a door lock and a rule comprising a condition for using the key and an action to be performed when the condition is satisfied, from a server via a communication module;
storing the key and the rule in a memory;
receiving an event occurring inside or outside the electronic device; and
performing the action on the basis of the event and the rule.

12. The method of claim 11, wherein the method performs the action, and uses information associated with a result of performing the action as condition data for performing the rule.

13. The method of claim 11, wherein the method performs the action, and uses information associated with a result of performing the action as event information.

14-15. (canceled)

16. The method of claim 11, wherein the event includes at least one of user information, ID information, location information, and time information of the electronic device.

17. The method of claim 16, wherein the time information is received from the server.

18. The method of claim 11, wherein the action comprises a function of transmitting the key to the door lock or another electronic device, or a function of deleting the key from the memory.

19. The method of claim 18, wherein the event further includes a user input, and the method further comprises transmitting the key to another electronic device on the basis of the user input.

20. The method of claim 11, wherein the key comprises the rule.
